(19) United States
(12) Patent Application Publication
(10) Pub. No.: US 2022/0028214 A1
(43) Pub. Date: Jan. 27, 2022

(54) SYSTEMS AND METHODS FOR PROVIDING A SECONDARY CURRENCY FOR USE IN AN ELECTRONIC GAMING ENVIRONMENT

(71) Applicant: Aristocrat Technologies, Inc., Las Vegas, NV (US)

(72) Inventors: Erick Ching, Cedar Park, TX (US); Hanna Sanborn, Georgetown, TX (US); Jeffrey Uss, Liberty Hill, TX (US); Chad La Guardia, Austin, TX (US); Rogelio Decasa, JR., Renton, WA (US); Jennifer Mizzi, Round Rock, TX (US); Peter Wasielewski, Austin, TX (US); Daniel Marks, Decatur, GA (US); Hua Xu, Marietta, GA (US)

(21) Appl. No.: 16/937,748

(22) Filed: Jul. 24, 2020

(51) Int. Cl. G07F 17/32

(52) U.S. Cl. CPC G07F 17/3244; G07F 17/3227

(57) ABSTRACT

An electronic gaming system is described including a display device, a random number generator (RNG), a player input interface, a game controller, and a tangible, non-transitory, computer-readable medium, storing instructions. The instructions, when executed by the game controller, cause the game controller to receive a wager amount of a first currency, cause a first electronic game to be displayed, and determine, based on an RNG call, an outcome of the first electronic game. The instructions also cause the game controller to determine, based at least on the outcome of the first electronic game, the wager amount, and a first pay table, whether to display a primary award. The instructions further cause the game controller to determine, based on a second RNG call and a second pay table, that a secondary award is to be displayed on the display device, the secondary award including a secondary currency.

### TECHNICAL FIELD

The field of disclosure relates generally to electronic gaming, and more particularly, to network-based systems and methods for providing a secondary currency for use in an electronic gaming environment.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for ready identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

### BRIEF DESCRIPTION

In one aspect, an electronic gaming system is described. The electronic gaming system includes at least one display device, a random number generator, a player input interface, a game controller, and a tangible, non-transitory, computer-readable medium, storing instructions. The instructions, when executed by the game controller, cause the game controller to at least receive a wager amount of a first currency at the player input interface, cause a first electronic game to be displayed on the at least one display device, and determine, based on a first random number generator (RNG) call, an outcome of the first electronic game. The instructions also cause the game controller to determine, based at least on the outcome of the first electronic game, the wager amount, and a first pay table, whether to display a primary award including the first currency. The instructions further cause the game controller to determine, based on a second RNG call and a second pay table, that a secondary award is to be displayed on the at least one display device, the secondary award including a secondary currency different from the first currency and cause display of the secondary award on the at least one display device, the secondary award including the secondary currency.

### BRIEF DESCRIPTION OF THE DRAWINGS

FIG. 1 is an exemplary diagram showing several EGMs networked with various gaming related servers.

FIG. 2A is a block diagram of an example EGM that includes exemplary internal electronic components, and connections to exemplary gaming systems in accordance with the present disclosure.

FIG. 2B depicts an example casino gaming environment in accordance with the present disclosure.

FIG. 2C is a diagram that shows examples of components of a system for providing online gaming in accordance with the present disclosure.

FIG. 3 illustrates, in block diagram form, an embodiment of a game processing architecture algorithm that implements a game processing pipeline for the play of a game in accordance with various embodiments described herein.

FIGS. 4-6 are example display areas on an EGM displayed during play of an electronic game in accordance with the present disclosure.

FIG. 7 is an example process of generating a secondary currency for use in an electronic gaming environment in accordance with the present disclosure.

FIGS. 8-11 are example display areas displayed during play of an electronic game in accordance with the present disclosure.

### DETAILED DESCRIPTION

Embodiments of the present disclosure provide systems and methods for generating, tracking, and redeeming a secondary currency for use in an electronic gaming environment. More specifically, an electronic gaming system provides an electronic game that includes at least one game (e.g., a base game), wherein a determination is made as to an award of a primary currency (e.g., a number of credits), and a determination is made as to an award of a secondary currency, different from the primary currency (e.g., a number of gems, coins, charms, hammers, other collectibles, etc.). For example, during play of a game, a player may wager an amount of a primary currency for play in the game. An outcome of the game is then determined, and an amount of primary currency to be awarded to the player is determined based on the game outcome. An amount of secondary currency, different from the primary currency, to be awarded to the player is also determined based on the game outcome in an example embodiment. In some embodiments, the amount of primary currency to be awarded and the amount of secondary currency to be awarded may be determined by utilization of different pay tables for each of the primary currency and the secondary currency. In some embodiments, the game may be a base game. In some embodiments, the game may be a game different from a base game such as a bonus game or a feature game. In some embodiments, secondary currency may be earned (e.g., as a daily award) and spent (e.g., for display enhancements) by a player in an electronic gaming environment but outside of the electronic game itself. Notably the secondary currency is a currency that may be spent by players to acquire bonuses, enhancements, etc. as described herein, but is not the bonus, enhancement, etc. itself. For example, in some embodiments secondary currency may be spent to acquire free spins in an electronic game. In these embodiments, the secondary currency is not the free spins themselves, but rather is a currency that may be spent to acquire the free spins.

The technical effects and advantages achieved by this system include at least one of: (a) engaging a player by awarding different types of awards; (b) improving player experience during a game by offering a chance to win an amount of a secondary currency even if no primary currency is awarded; (c) enhancing game play by providing a player with options to enhance a game by spending a secondary currency, thereby potentially affecting the RTP of the game for the player; (d) encouraging players to play different kinds of games by rotating games that may award the secondary currency; (e) encouraging players to play different kinds of games by rotating games wherein the secondary currency may be spent; and (f) improving player experience by providing a player with amounts of the secondary currency on a periodic basis without requiring play of a game.

The technical improvements implemented to provide secondary currency in this system include at least one of: (a) storing and utilizing multiple pay tables to determine primary currency and secondary currency payouts; (b) improved data storage for storing and tracking primary currency and secondary currency; (c) enabling players to use secondary currency in multiple electronic games; (d) providing a secondary currency that may be spent and acquired at land-based casinos and in virtual environments; (e) improved user interface to communicate to players how to earn secondary currency in addition to primary currency; and (f) improved user interface to communicate to players a balance of primary currency and secondary currency.

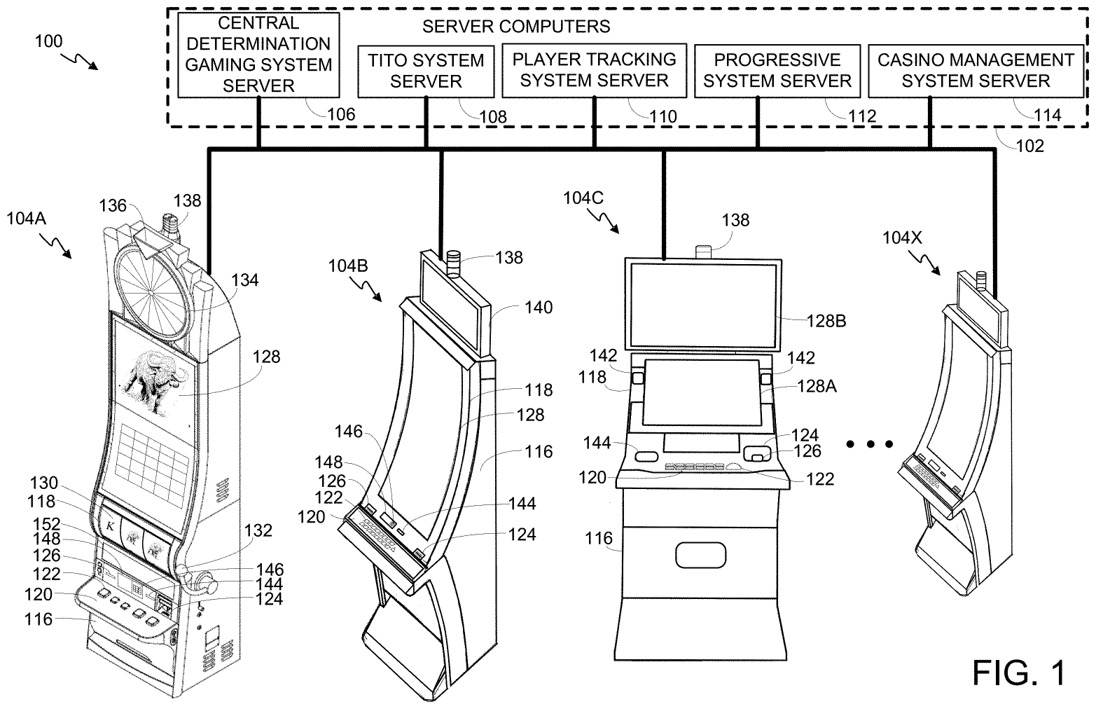

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some embodiments, server computers 102 may not be necessary and/or preferred. For example, in one or more embodiments, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution LCD, plasma, LED, or OLED panel which may be flat or curved as shown, a cathode ray tube, or other conventional electronically controlled video monitor.

In some embodiments, the bill validator 124 may also function as a “ticket-in” reader that allows the player to use a casino issued credit ticket to load credits onto the gaming device 104A (e.g., in a cashless ticket (“TITO”) system). In such cashless embodiments, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some embodiments, a player tracking card reader 144, a transceiver for wireless communication with a mobile device (e.g., a player's smartphone), a keypad 146, and/or an illuminated display 148 for reading, receiving, entering, and/or displaying player tracking information is provided in EGM 104A. In such embodiments, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), paylines, pay tables, and/or various game related graphics. In some embodiments, the information panel(s) 152 may be implemented as an additional video display.

Gaming devices 104A have traditionally also included a handle 132 typically mounted to the side of main cabinet 116 which may be used to initiate game play.

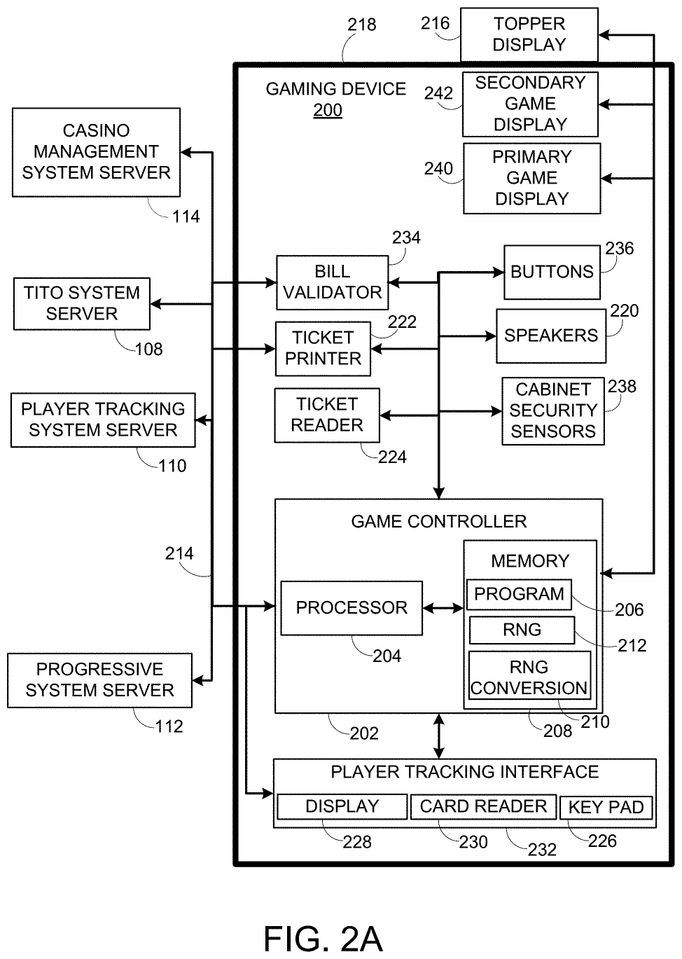

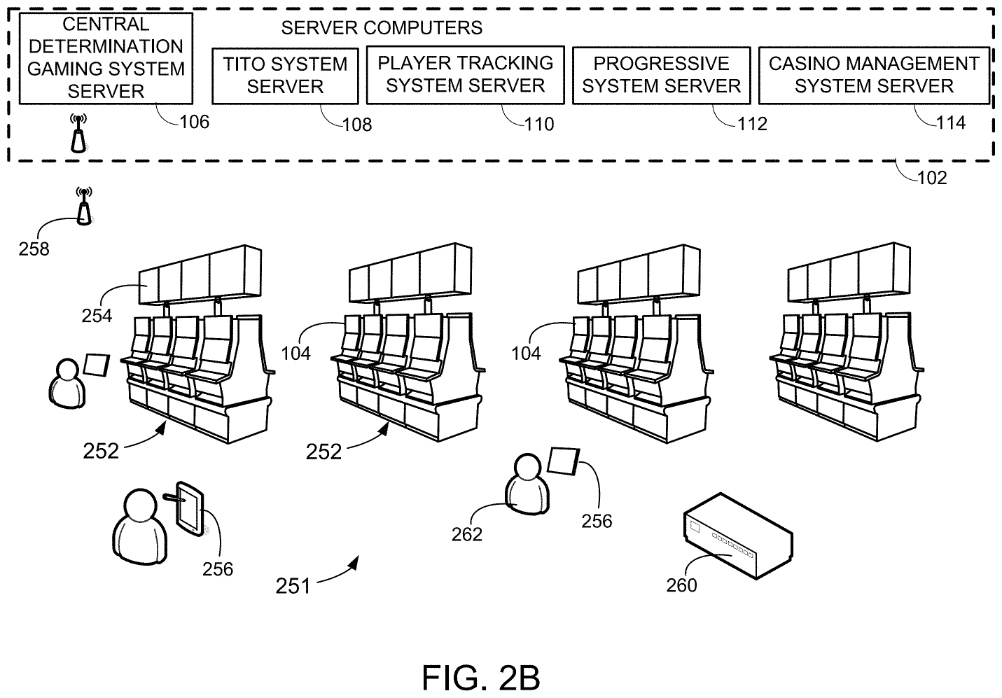

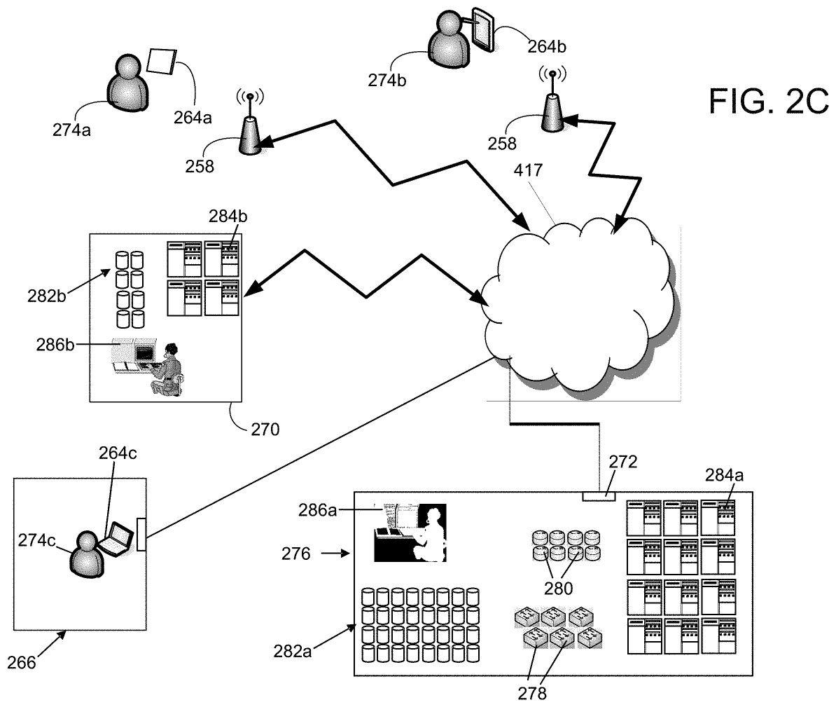

Many or all the above described components can be controlled by circuitry (e.g., a game controller) housed inside the main cabinet 116 of the gaming device 104A, the details of which are shown in FIG. 2.

An alternative example gaming device 104B illustrated in FIG. 1 is the Arc™ model gaming device manufactured by Aristocrat® Technologies, Inc. Note that where possible, reference numerals identifying similar features of the gaming device 104A embodiment are also identified in the gaming device 104B embodiment using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some embodiments, topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the landscape display 128A may have a curvature radius from top to bottom, or alternatively from side to side. In some embodiments, display 128A is a flat panel display. Main display 128A is typically used for primary game play while secondary display 128B is typically used for bonus game play, to show game features or attraction activities while the game is not in play or any other information or media desired by the game designer or operator. In some embodiments, example gaming device 104C may also include speakers 142 to output various audio such as game sound, background music, etc.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems in accordance with the present disclosure. All or parts of the example gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), and a card reader 230 for receiving data and/or communicating information to and from media or a device such as a smart phone enabling player tracking. FIG. 2A also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that does not retain data values upon loss of power. Nonvolatile memory is memory that does retain data upon a loss of power. Examples of memory 208 include random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various embodiments (e.g., game mechanics) described herein. Stated another way, game program 206 represents an executable program stored in any portion or component of memory 208. In one or more embodiments, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be setup to generate one or more game instances based on instructions and/or data that gaming device 200 exchange with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208. Note that embodiments of the present disclosure represent an improvement in the art of EGM software and provide new technology in that they provide for a secondary currency, different from a traditional primary currency, which can be awarded to players and spent by players to further enhance the player experience in a gaming environment (e.g., a casino gaming environment, a virtual/mobile gaming environment, etc.), and, in some embodiments, more than one gaming environment (e.g., the same secondary currency may be spent in a casino and in a virtual/mobile gaming environment). These embodiments are thus not merely new game rules or simply a new display pattern.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 includes an RNG 212 that utilizes hardware and/or software to generate RNG outcomes that lack any pattern. The RNG operations are often specialized and non-generic in order to comply with regulatory and gaming requirements. For example, in a reel game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more embodiments, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can setup the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

In the example embodiment, multiple RNGs 212 are provided in addition to multiple lookup/pay tables in order to implement the secondary currency. Further, additional data storage is utilized such that secondary currency is stored in a way that allows the secondary currency to be spent in land-based casinos, as well as in virtual environments and so that electronic games wherein secondary currency may be spent and/or earned are tracked automatically. Additionally, display device performance is improved to communicate information regarding secondary currency to players (e.g., how to earn secondary currency, how much secondary currency has been earned, etc.).

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g. amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gamine device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Although FIGS. 1 and 2A illustrate specific embodiments of a gaming device (e.g., gaming devices 104A-104X and 200), the disclosure is not limited to those embodiments shown in FIGS. 1 and 2A. For example, not all gaming devices suitable for implementing embodiments of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Additionally, or alternatively, gaming devices 104A-104X and 200 can include credit transceivers that wirelessly communicate (e.g., Bluetooth or other near-field communication technology) with one or more mobile devices to perform credit transactions. As an example, bill validator 234 could contain or be coupled to the credit transceiver that output credits from and/or load credits onto the gaming device 104A by communicating with a player's smartphone (e.g., a digital wallet interface). Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2A are examples to facilitate ease of description and explanation.

FIG. 2B depicts an example casino gaming environment in accordance with the present disclosure. In this example, the casino 251 includes banks 252 of EGMs 104. In this example, each bank 252 of EGMs 104 includes a corresponding gaming signage system 254. According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming in accordance with the present disclosure. As with other figures presented in this disclosure, the numbers, types and arrangements of gaming devices shown in FIG. 2C are merely shown by way of example. In this example, various gaming devices, including, but not limited to, end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 570a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations, one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

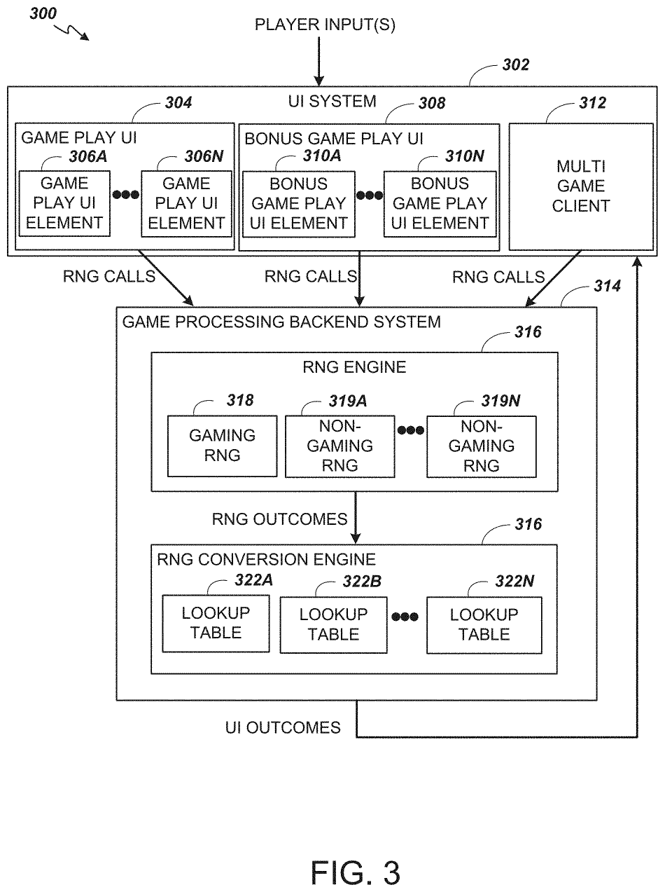

FIG. 3 illustrates, in block diagram form, an embodiment of a game processing architecture 300 that implements a game processing pipeline for the play of a game in accordance with various embodiments described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more embodiments, at least some of the game play UI element 306A-306N are similar to the bonus game play UI elements 310A-310N. In other embodiments, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 corresponds to RNG 212 shown in FIG. 2. As previously discussed with reference to FIG. 2, gaming RNG 318 often performs specialized and non-generic operations that comply with regulatory and/or game requirements. For example, because of regulation requirements, gaming RNG 318 could be a cryptographic random or pseudorandom number generator (PRNG) (e.g., Fortuna PRNG) that securely produces random numbers for one or more game features. To generate random numbers, gaming RNG 318 could collect random data from various sources of entropy, such as from an operating system (OS). Alternatively, non-gaming RNGs 319A-319N may not be cryptographically secure and/or be computationally less expensive. Non-gaming RNGS 319A-319N can, thus, be used to generate outcomes for non-gaming purposes. As an example, non-gaming RNGs 319A-319N can generate random numbers for such as generating random messages that appear on the gaming device.

The RNG conversion engine 320 processes each RNG outcome from RNG engine 316 and converts the RNG outcome to a UI outcome that is feedback to the UI system 302. With reference to FIG. 2, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

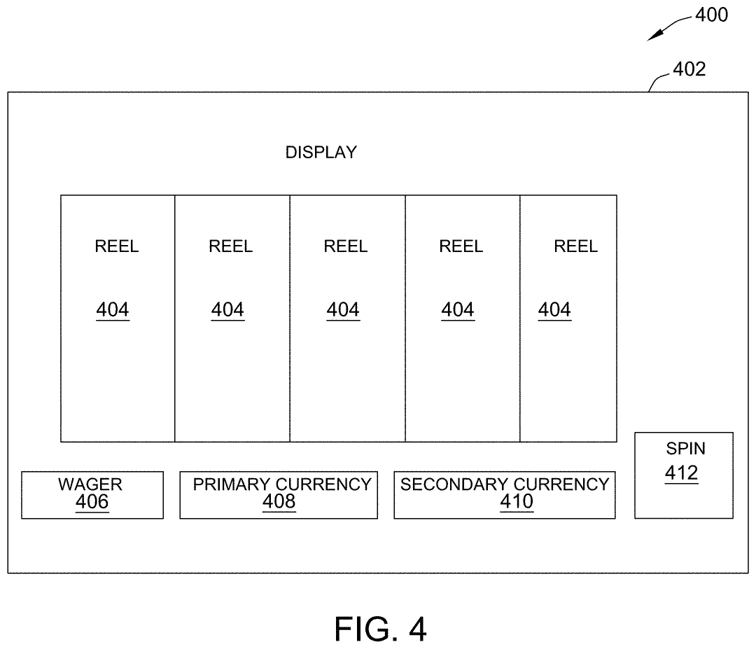

FIG. 4 is an example display area 400 displayed during play of an electronic game in accordance with the present disclosure. In some embodiments, display area 400 may be included on an EGM (e.g., EGMS 104A-104X) or EUD (e.g., EUDS 264a-264c) as described herein. Display area 400 includes display 402, which may be similar to primary game display 240 or any other display as described herein. Shown on display 402 are, as examples, a plurality of reels 404, a current wager display area 406, a primary currency display area 408, a secondary currency display area 410, and a spin button 412.

In the example embodiment, reels 404 may embody reels 130, or any reels as described herein. Reels 404 may be used during play of an electronic game (e.g., a base game, bonus game, feature game, etc.) such that reel symbols displayed at positions on the reels communicate a game outcome to a player. For example, reels 404 may display reel symbols such that if the reel symbols are aligned with a payline as described above, the player will be presented with an award.

When a player places a wager during play of an electronic game, the amount being wagered by the player may appear in current wager display area 406. For example, if a player wagered one hundred credits for a particular play of a game, the number one hundred would appear in current wager display area 406. Upon placing a wager, or otherwise designating a wagering amount, a player may initiate play of a game being displayed on display 402 by selecting (e.g., touching) spin button 412. After selecting spin button 412, reels 404 will spin and eventually stop, displaying reel symbols at various reel positions.

Upon player selection of spin button 412, a game controller (e.g., game controller 202) communicatively coupled to display 402 may determine a game outcome by utilizing at least one RNG and at least one lookup table (e.g., RNG 318 and lookup table 322A). Once a game outcome is determined, reel symbols and positions of the reel symbols to be displayed on reels 404 are determined. Accordingly, when reels 404 have stopped spinning, the determined reel symbols are displayed at the determined reel positions. The game controller then determines, based on the game outcome, an award to be presented to a player. Continuing the example described above, the game controller may determine that, based on the game outcome and the wager placed by the player of one hundred credits, the player should be awarded two hundred credits. Accordingly, the number two hundred may appear in primary currency display area 408.

In the example embodiment, primary currency is defined as currency used for a primary wager in an electronic game and a primary award presented (if any award is to be presented) as a result of the outcome of the electronic game. For example, as described in the example above, the player placed a wager of one hundred credits and received an award of two hundred credits. Accordingly, in this example, “credits” are the primary currency. While described as currency, the primary currency may not be tied to a monetary form of currency. Instead, it may be a currency, such as credits, used by a wagering provider, such as a casino, online wagering provider, social gaming provider, etc.

In the example embodiment, secondary currency is defined as a currency that may be used by a player in the wagering game, and awarded to a player, that is separate from the primary currency. For example, if credits are the primary currency as described above, the secondary currency may be any currency other than credits (e.g., virtual gems, virtual collectibles, points, virtual charms, virtual hammers, etc.). In the example embodiment, secondary currency awarded to a player may be displayed in secondary currency display area 410.

In the example embodiment, secondary currency may be awarded to a player for a variety of reasons, some of which are listed below. In some embodiments, secondary currency may be awarded to a player on a daily basis or at any other predetermined interval, in some embodiments, regardless of whether an electronic game is played by the player or not. This may be tied to some type of gaming activity. In some embodiments, secondary currency may be awarded based on an evaluation of a secondary pay table stored within the EGM memory with the game outcome of an electronic game (e.g., reel symbols displayed at different positions), different from a primary pay table used to determine an amount of primary currency to award to a player. For example, evaluation of a first pay table with the game outcome may result in the player being awarded 100 credits (primary currency), while evaluation of a second pay table with the game outcome may result in the player being awarded 10 diamonds (secondary currency). As another example, a player may be awarded secondary currency based on the game outcome even when no primary currency is awarded. Further, a player may be awarded secondary currency based on the display of reel symbols that would normally not result in a payout (e.g., 3 bonus symbols are required to trigger bonus game, but secondary currency is awarded if only 1 or 2 bonus symbols appear). The player experience of playing games including secondary currency is thus improved by the chance of earning not only a primary currency, but also a secondary currency. The EGM is also improved to be able to track both the primary currency and secondary currency, along with storing data necessary to provide and accept secondary currency from a player. The EGM is further improved by storing and utilizing multiple pay tables to determine primary currency and secondary currency payouts, configuring a secondary currency for use (e.g., spending and/or acquiring) at land-based electronic gaming environments (e.g., casinos) and in virtual electronic gaming environments. The EGM and user interface improvements associated therewith include providing an improved user interface to communicate to players how to earn secondary currency in addition to primary currency and providing an improved user interface to communicate to players a balance of primary currency and secondary currency.

As another example, sub-symbols may be located on certain symbols at different reel positions. When a quantity, such as three, of the sub-symbols, as an example, appear during any particular play of an electronic game, secondary currency may be awarded to the player. For example, in a restaurant themed game, the appearance of steak, wine, and baked potato symbols may initiate an award of secondary currency to a player (e.g., because the three sub-symbols complete a restaurant order). In some embodiments, sub-symbols needed to earn secondary currency may be displayed to the player at a position outside of the reels so that the player knows which sub-symbols to look for to earn secondary currency. In another example, dice may be a sub-symbol that can appear during play of an electronic game. When two or more dice appear on the reels during play of an electronic game, those dice are rolled and the total amount displayed thereon after the roll is presented to the player as secondary currency.

In some embodiments, sub-symbols may be collected throughout multiple plays of an electronic game as described herein. Collecting enough of these sub-symbols may trigger the player being awarded secondary currency. An example of this would be a garden themed game. A garden may be displayed on a display device (e.g., display 128). Collecting watering can sub-symbols during multiple plays of an electronic game would trigger an animation showing different spots in the displayed garden being watered. When a plant fully blooms, it is harvested and the player is awarded secondary currency for the harvest. In the examples described herein, the EGM is improved by providing various user interface improvements. For instance, in the example described above, a meter may be displayed that tracks the progress toward a plant blooming in the virtual garden. Further, the EGM tracks and analyzes player progress toward earning secondary currency and accordingly causes display of various animations on at least one display device of the EGM (e.g., causing display of a garden being watered, etc.)

In some embodiments, a player may be awarded secondary currency based on certain symbols appearing over multiple plays of an electronic game (e.g., collecting symbols over the course of 10 spins). For example, a meter may track the quantity of certain symbols that have appeared throughout the different plays of the electronic game. Upon the certain symbol appearing, for example, 20 times total throughout the different plays of the electronic game, the player may be awarded secondary currency. The meter would then reset and begin displaying a new count up starting from zero.

In some embodiments, the secondary symbols may be displayed using a one or more paytables tied to the primary game outcome. In some embodiments, the determination to display secondary symbols may be based on paytables not tied to the primary game outcome. For example, in some embodiments, a random determination may be made whether to display one or more secondary symbols in the game outcome, that is not affected by the primary game outcome. The determinations may be individual for each reel, each symbol position, etc., or may be in the aggregate (number of secondary symbols to display). Further, these may be tied to a weighted table to control the probability of occurrence.

In some embodiments, secondary currency may only be awarded based on an outcome of a base game. In some embodiments, secondary currency may only be awarded based on an outcome of a bonus game and/or feature game. In some embodiments, secondary currency may be awarded based on an outcome of any electronic game.

For example, symbols may be “collected” during play of a bonus game and/or free game as described above with respect to an electronic game. Secondary currency may also be earned during a bonus game and/or free game by achieving goals such as, as examples, winning a certain amount of credits in the bonus, getting a certain number of wins, and/or winning on specific paylines.

In some embodiments, secondary currency may be used to place a wager in an electronic game, while in other embodiments secondary currency may be currency that cannot be used to place a wager in an electronic game. In some embodiments, in order to receive secondary currency as an award from an electronic game, an amount of secondary currency may need to be placed as a wager by a player (in some embodiments, in addition to a primary wager of the electronic game including a primary currency amount). In some embodiments, in order to receive an award of secondary currency, an additional wager of primary currency must be made by a player.

In some embodiments, in order to earn secondary currency during play of an electronic game, a secondary wager (e.g., of primary currency or secondary currency) may be required. For example, play of an electronic game may normally require a player to wager an amount of credits (e.g., 50 credits). However, in an example embodiment, a player may be able to wager an additional amount of credits (e.g., 25 extra credits, for a total wager of 75 credits) in order to unlock the ability to earn secondary currency during play of the electronic game. In some embodiments, wagering an additional amount of credits may unlock an additional feature during play of the electronic game (e.g., an additional wheel being displayed, an additional display device being activated, etc.).

In some embodiments, secondary currency may be awarded based on display of a secondary currency reel symbol, regardless of the position of the secondary reel symbol. In other words, while typical awards presented to a player are determined based on paylines associated with reel symbols being displayed at certain positions on reels, the mere appearance of a secondary currency reel symbol on reels 404 may indicate and/or initiate the awarding of secondary currency to a player. In some embodiments, a secondary currency reel symbol may be similar to the type of secondary currency to be awarded to the player. For example, if the secondary currency to be awarded to a player is an amount of gems, a gem symbol may be the secondary currency reel symbol.

In some embodiments, secondary currency may be awarded to a player based on player achievement of goals separate from game outcomes themselves. For example, secondary currency may be awarded to a player for playing a particular game, or playing at a particular machine, for a predetermined amount of time. In some embodiments, secondary currency may be awarded to a player for playing a particular wagering game for a predetermined amount of times. In some embodiments, secondary currency may be awarded to a player at random (e.g., as determined by an RNG as described herein). In some embodiments, a player may have to achieve a goal in a certain amount of time in order to receive secondary currency.

For example, an animation may appear on an EGM that communicates to a player that if the player can win at least 1,000 credits (primary currency) in the next minute, they will be awarded 10 diamonds (secondary currency). A meter may track how many credits have been earned over the given time period (in this example, one minute). Other goals, as examples, include collecting a predetermined number of a specific symbol within a time frame, being awarded a predetermined number of big wins (e.g., 10× the player's bet), and being awarded a predetermined number of bonus triggers (e.g., bonus symbols).

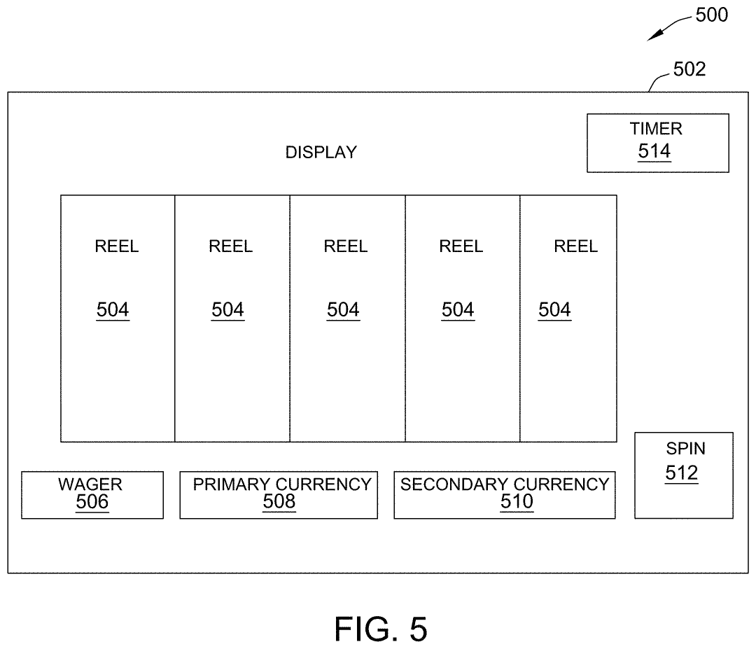

FIG. 5 is an example display area 500 displayed on an EGM during an electronic game in accordance with the present disclosure. In some embodiments, at least some portions of display area 500 may embody portions of display area 400. In some embodiments, display area 500 may be included on an EGM (e.g., EGMS 104A-104X) or EUD (e.g., EUDS 264a-264c) as described herein. Display area 500 includes display 502, which may be similar to primary game display 240 or any other display as described herein. Shown on display 502 are, as examples, a plurality of reels 504, a current wager display area 506, a primary currency display area 508, a secondary currency display area 510, a spin button 512, and a timer display area 514.

As described above, in some embodiments a player may earn secondary currency by playing an electronic game for a predetermined amount of time (e.g., a predetermined number of plays). Further, also as described above, in some embodiments a player may receive an amount of secondary currency at predetermined time intervals. In some embodiments, such as those described above, timer display area 514 may display an amount of time remaining before a player receives an amount of secondary currency. In some embodiments secondary currency may only be active for a predetermined amount of time (e.g., may only be spent for a predetermined amount of time). In these embodiments, timer display area 514 may display an amount of time remaining before the secondary currency, or a portion of secondary currency, will expire (e.g., may no longer be spent).

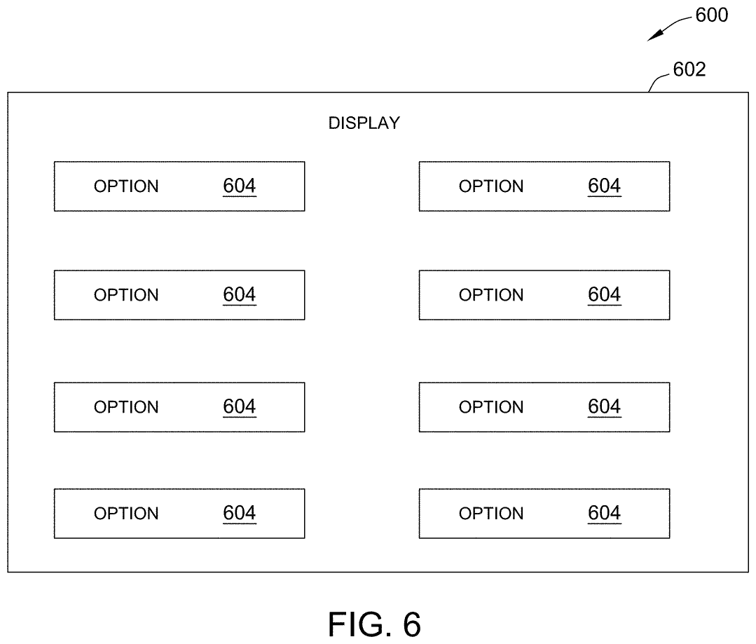

FIG. 6 is an example display area 600 displayed on an EGM during an electronic game in accordance with the present disclosure. In some embodiments, display area 600 may be included on an EGM (e.g., EGMS 104A-104X) or EUD (e.g., EUDS 264a-264c) as described herein. Display area 600 includes display 602, which may be similar to primary game display 240 or any other display as described herein. Shown on display area 602, in the example shown in FIG. 6, are a plurality of options 604 a player may select as ways to spend secondary currency.

In the example embodiment, secondary currency may be used by a player in a variety of ways. For example, options 604 may include some of the options listed below. In some embodiments, secondary currency may be spent by a player to enhance the outcome and/or play of an electronic game. As an example, secondary currency may be spent by a player to multiply an award value to be presented to the player (e.g., 2×). In some embodiments, secondary currency may be spent by a player to provide at least one free spin of an electronic game (e.g., a spin of reels with the possibility of providing a player with an award, without requiring a wager amount of a primary or secondary currency).

In some embodiments, secondary currency may be spent by a player to initiate a bonus game and/or feature game. For example, a bonus game and/or feature game may normally only be initiated based on a particular game event/outcome being determined. However, in some embodiments secondary currency may be spent by a player to initiate the bonus game and/or feature game without the particular game event/outcome occurring. For example, spending secondary currency may increase the chances of a bonus and/or feature game being triggered by changing the requirements for triggering the bonus and/or feature game (e.g., requiring only two bonus symbols appear to trigger the bonus and/or feature, as opposed to three). In some embodiments, a bonus and/or feature game may be triggered immediately upon the player spending secondary currency. As another example, an additional bonus game (e.g., a super bonus game including the possibility of a player being presented with higher value awards than are available during play of the bonus game) may be provided after a certain number of times a regular bonus game is triggered. For example, after ten triggers of the regular bonus game, a super bonus may be available. In some embodiments, spending secondary currency may reduce the number of times the bonus game needs to be triggered in order to unlock the super bonus (e.g., five times as opposed to ten times).

In some embodiments, secondary currency may be spent by a player to unlock additional features for one or more spins/future plays of an electronic game. As examples, spending secondary currency may add features such as random symbols being converted to wild symbols, a larger display area being displayed (e.g., with more reels displayed thereon), and/or a random spin multiplier (e.g., increasing the amount of spins and/or increasing the payout resulting from the spin(s)).

In some embodiments, secondary currency may be spent by a player to re-play a bonus game and/or feature game. For example, a player may be disappointed by an outcome of a highly-anticipated bonus game and/or feature game. In some embodiments, spending of secondary currency may allow a player to re-play a particular bonus game and/or feature game. In some embodiments, an amount of secondary currency required to re-play an electronic game may increase depending on how many times the player has already re-played the electronic game. For instance, re-playing an electronic game for a third time may cost more secondary currency than re-playing an electronic game for a second time. As another example, instead of re-playing an entire bonus game and/or feature game, a player may be able to spend secondary currency to earn an additional spin during a game being played. For instance, if the appearance of three bonus symbols is required to trigger a bonus, and only two bonus symbols appear after a final spin of an electronic game, a player may be able to spend secondary currency to earn one or more additional spins to try to have a third bonus symbol appear so that the bonus is triggered. In these embodiments, a full re-spin may be made (e.g., each reel is spun), or a partial re-spin may be made (e.g., such that certain reels, such as the reels with bonus symbols displayed thereon, do not spin but the reels not displaying bonus symbols do spin).

In some embodiments, secondary currency may be spent by a player to improve RTP (return to player, as described above) of an electronic game (e.g., an improved RTP is enabled during play of the electronic game). For example, spending secondary currency may increase payouts awarded to a player or the triggering of a bonus and/or feature game. As another example, a player may spend secondary currency to unlock new positions on a wheel for a game including wheel spins. The new positions on the wheel may include bigger prize amounts displayed thereon than were previously displayed on the wheel, such that the player spending secondary currency unlocks the ability to earn bigger prize amounts.

In some embodiments, secondary currency may be used to place a side bet during play of an electronic game (e.g., a wager placed on game aspects separate from game aspects evaluated to determine a game award of primary currency). As an example, placing a side bet of secondary currency causes a game outcome (e.g., display of symbols on reel positions) to be evaluated against a second pay table, in addition to evaluation against a first pay table upon play of an electronic game. During play of the game described above, without a side bet of secondary currency, the game outcome would only be evaluated against the first pay table. However, by placing the side bet of secondary currency, the player has unlocked the ability to earn bigger wins because the game outcome is evaluated against two pay tables as opposed to one pay table.

In some embodiments, a player may spend secondary currency to progress towards achievement of a goal. For example, as described above, in some embodiments secondary currency may be awarded to a player at predetermined intervals of time. However, in some embodiments, a player may spend secondary currency in order to decrease, or speed up, the intervals of time at which they are presented with secondary currency. In some embodiments a game may be unlocked at a predetermined interval of time (e.g., a wheel spin, special reel strips in an electronic game, selecting a loot chest, etc.) providing the opportunity for a player to earn secondary currency by playing the game appearing at the predetermined interval. In some embodiments the bonuses described above providing the ability to earn secondary currency may be presented to a player for reasons other than intervals of time (e.g., reaching a new level on a player account, winning a competitive bonus, completing a goal such as playing a certain number of spins/winning a certain amount of credits, etc.). In some embodiments, secondary currency may be spent by a player to unlock/be awarded with prizes determined at random (e.g., determined by an RNG as described above). For example, a player may be able to purchase items/collectibles such as a virtual loot box that, when opened, provides the player with a random award.

In some embodiments, secondary currency may only be spent during play of certain electronic games or on certain EGMs. For example, in order to encourage players to play different varieties of electronic games, electronic games during which secondary currency may be earned and/or spent may change periodically. As an example, in order to increase play of a new electronic game, secondary currency may be available to be earned and/or spent on the new electronic game. Then, once the new electronic game has increased in popularity, electronic currency may no longer be able to be spent and/or earned on the new electronic game. In some embodiments, secondary currency may be spent in a land-based casino, as well as virtually (e.g., at EUD 264 as described above). Accordingly, changing games during which secondary currency can be earned and/or spent may be used to encourage to play more land-based games at a casino and or more virtual games at an EUD. Similarly, changing games during which secondary currency can be earned and/or spent may be used to drive player traffic from one land-based game to a different land-based game, and or from one virtual game to a different virtual game. As an example, in some embodiments, secondary currency may be spent by a player during play of an electronic game at an EUD as described herein (e.g., a cell phone). After spending the secondary currency at the EUD, the player may earn primary currency and secondary currency. In some embodiments, the primary currency and/or secondary currency can be earned and/or spent at an EUD (e.g., in a virtual gaming environment) and at an EGM (e.g., in a land-based gaming environment). In other words, primary currency and/or secondary currency may be earned in one environment, and spent in another (e.g., earned at an EUD and spent at an EGM, etc.).

As another example of how secondary currency as described herein may be used to drive player traffic to certain games, in some embodiments secondary currency that is earned by a player may be stored in a central player account (e.g., in a lobby). The player then has access to spend secondary currency in any eligible games where secondary currency may be spent. However, in order to drive player traffic to particular games, the value of secondary currency in different games may change. As examples, if it is desired that more players play a particular game, secondary currency may be worth five times its normal value in that particular game. In some embodiments, secondary currency may be spent to earn primary currency (e.g., primary currency, a tertiary currency, etc.). For example, in some embodiments a tertiary currency may be required to play a particular game. In some embodiments, secondary currency may be spent to acquire tertiary currency that can then be used to be able to play the particular game.

The player account may be stored in a database associated with a server such as the player tracking system server 110. The player account may be associated with player credentials, which the player may use, to sign in on an EGM 104X. The player may also use a player card to sign in on EGM 104X.

In some embodiments, a player may spend secondary currency in order to play an electronic game that is only offered to players who spend secondary currency to play the game. For example, if an electronic game is set to be released to players in the future, electronic game providers may offer early access to this electronic game to players who spend secondary currency to access the to-be-released electronic game.

In some embodiments, secondary currency may be spent to enhance different aspects of an electronic game as described herein. As further examples, spending secondary currency may result in additional features being added to the electronic game (e.g., different symbols, animations, etc.) and potential payouts to a player may increase.

In some embodiments, secondary currency may also be spent in order to further progression towards completion of a collection or achievement of a goal. For example, electronic games may be associated with various animations displayed to a player (e.g., at EUD 264) different from the electronic game itself. As examples, a player account associated with a player may include a player virtual avatar and/or a player virtual town (e.g., including various virtual buildings, etc.). In some embodiments, buildings in the virtual town may be “built” (e.g., by animation at EUD 264) by a player spending primary currency. Spending secondary currency may increase the speed with which the building is built, or enhance any other aspect of the virtual town. For example, the secondary currency in these embodiments may be virtual hammers. Some buildings may only be able to be built by a player spending secondary currency. A player may be motivated to build more buildings because, as an example, the number of buildings in a player town may increase the amount of a daily reward presented to a player.

In embodiments including a virtual avatar, a player may spend secondary currency to enhance the virtual avatar (e.g., by acquiring different pieces of virtual clothing, virtual accessories, etc. that the virtual avatar can be displayed as wearing). For example, some avatar enhancements may be given to a player without any cost, and some enhancements may be provided upon a player spending primary currency. However, in some embodiments, secondary currency may be spent by a player to acquire avatar enhancements only available by spending secondary currency. In some embodiments, secondary currency may be spent to acquire any avatar enhancement available. In some embodiments, a player may be able to move their virtual avatar through a virtual town and/or in to different virtual buildings as described above. While playing an electronic game at an EUD (e.g., EUD 264), as an example, the player avatar may be displayed to the player in a particular position (e.g., sitting at a virtual poker table, at a virtual EGM, etc.). In some embodiments, a player may cause display of different “emotes” (e.g., animations displayed near a virtual avatar). For example, when a player causes display of an emote near their virtual avatar, other players controlling their respective avatars at their respective EUDs may see the avatar and/or the emote (e.g., players with virtual avatars sitting around the same virtual poker table can see emotes displayed near any avatar at that virtual poker table). In some embodiments, certain emotes may only be available to be purchased by a player by spending secondary currency. In some embodiments, certain animations may be displayed near the virtual avatar associated with the player earning the secondary currency. Other players with virtual avatars near the virtual avatar with the certain animation displayed therewith may see the animation, and thus be notified that secondary currency can be earned by playing that particular game.

In some embodiments, advertisements may be played in between some plays of an electronic game. In some embodiments, secondary currency may be spent in order to skip advertisements and advance directly to a next play of an electronic game. In some embodiments, secondary currency may be earned by a player viewing advertisements. In some embodiments, secondary currency may be spent to permanently unlock a feature of an electronic game. In some embodiments, secondary currency may be spent to unlock a feature of an electronic game for a predetermined amount of time. For example, spending secondary currency may increase the level of RTP for a particular wagering game for a particular amount of time, or permanently. As another example, spending secondary currency may decrease the interval at which secondary currency is awarded to a player without requiring play of an electronic game, either permanently or for a predetermined amount of time.

Although many examples are described herein, it should be appreciated that secondary currency may be spent for any kind of enhancement relating to an electronic game, whether merely decorative or enhancing a game outcome itself, or, as explained above, for an enhancement of other virtual aspects included in an application including electronic games and other animations (e.g., virtual towns, avatars, etc.). As further examples, secondary currency may be spent to purchase a virtual loot box which can award primary currency credits, additional secondary currency, or features or bonuses for the game, a card pack which can add to a player card collection (e.g., a player may complete collections of cards for prizes), primary currency credits, additional secondary currency, or features or bonuses for an electronic game. Other examples of what secondary currency may be spent for include unlocking a new slot game within an application, purchasing lottery tickets that are used for an application-wide jackpot, purchasing scratch cards that can award primary currency credits, additional secondary currency, features/bonuses for an electronic game, and/or purchasing adornments/ornaments that can change the appearance of an electronic game or a player avatar. In the examples described herein, many user interface improvements are provided by the system being able to award secondary currency, track secondary currency earned by a player, accept secondary currency spent by a player, and display a wide variety of animations that may be associated with the feature, bonus, etc. the secondary currency was spent by the player to acquire.

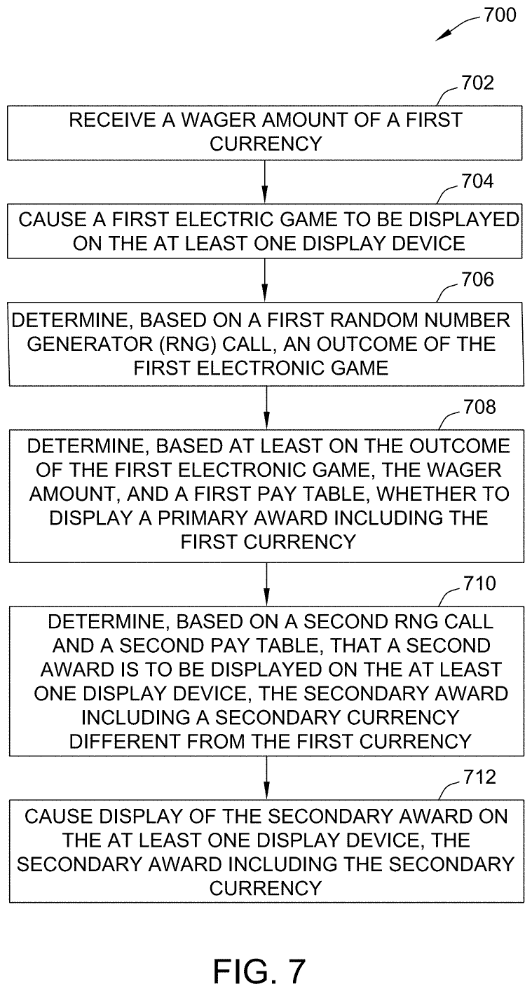

FIG. 7 is an example process 700 of generating secondary currency for use in an electronic gaming environment in accordance with the present disclosure. In the example embodiment, process 700 includes receiving 702 a wager amount of a first currency from a player and causing 704 a first electronic game to be displayed on a display device (e.g., display 128). Process 700 also includes determining 706 an outcome of the first electronic game based on a first RNG call and determining 708, based at least on the outcome of the first electronic game, the wager amount, and a first pay table, whether to display a primary award including a first currency. Process 700 further includes determining 710, based at least on a second RNG call and a second pay table, that a second award is to be displayed on the at least one display device, the secondary award including a secondary currency different from the first currency, and causing 712 display of the secondary award on the at least one display device, the secondary award including the secondary currency.

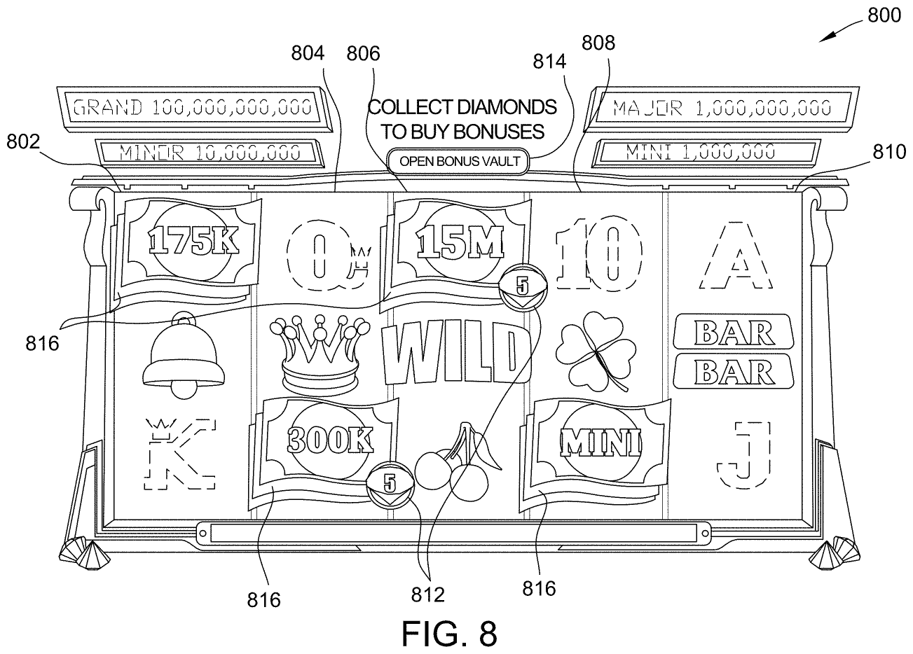

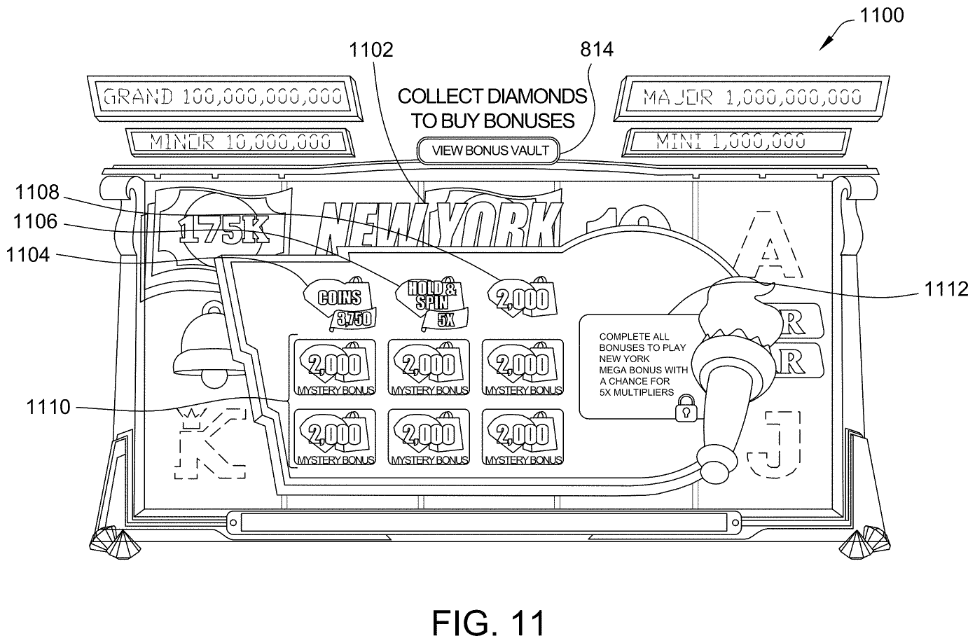

FIGS. 8-11 represent an example of an electronic game wherein secondary currency as described herein may be earned and spent. FIG. 8 is an example display area 800 displayed during a base game played on a display of a display device (e.g., display 128 of example EGMs 104A-X). Display area 800 includes a plurality of reels 802-810 upon which secondary currency symbols 812 may appear as described herein. While five reels are shown with a matrix of 3×5 reel positions, in some embodiments, any number of reels and/or dimensions of reel positions may be displayed. Display area 800 also includes an access button 814 (e.g., a virtual button as described herein) that a player may select to access different options for spending secondary currency as explained below with respect to FIG. 11. Display area 800 further includes bonus symbols 816 upon which secondary symbols 812 may be displayed.

In the example electronic game shown in FIG. 8, secondary currency may be collected in a variety of ways. For example, secondary currency may be added to a player account/balance upon secondary currency symbols 812 being displayed. The balance may include any previous secondary symbols accumulated by the player during play of any previous games, either at the same EGM or at a different EGM. In some embodiments, a game controller of an EGM is configured to present an additional award (e.g., different from an award presented as a result of a game outcome) to a player upon determining the player has accumulated a predetermined amount of secondary currency. As shown in FIG. 8, an example secondary currency may be gems. Display area 800 is displaying two secondary currency symbols 812 in FIG. 8 with the number “5” displayed therein. Accordingly, ten gems would be added to the player balance. In some embodiments, any number may appear in secondary currency symbols 812 such that secondary currency symbols 812 are what you see is what you get (WYSIWYG) symbols. In some embodiments, secondary currency symbols 812 may not display a number therein. In these embodiments, secondary currency symbols 812 may be associated with a predetermined or random amount of secondary currency to be awarded to the player upon display of secondary currency symbols 812. In some embodiments, upon secondary currency being awarded, secondary currency symbol 812 may overlay an entire position on a reel 802-810 for a predetermined amount of time before shrinking in size to be displayed in a corner of a reel position as shown in FIG. 8. In some embodiments, secondary currency symbols 812 may be displayed anywhere in display area 800.

In the example embodiment, when bonus symbols 816 are displayed there is a chance secondary currency may be awarded to a player of the electronic game. For example, as shown in FIG. 8, two of the four displayed bonus symbols 816 include secondary currency symbols 812. Thus, the two bonus symbols 816 with secondary currency symbols 812 displayed thereon indicate to a player that secondary currency will be awarded to the player. In some embodiments, secondary currency symbols 812 may appear on any symbol, not just bonus symbols 816. In some embodiments, the odds a secondary currency symbol 812 will be displayed may be higher for bonus symbols 816 (e.g., secondary currency symbols 812 have a higher chance of being displayed on bonus symbols 816) than with base game symbols. In some embodiments, secondary currency may be awarded even when no secondary currency symbols 812 are displayed.

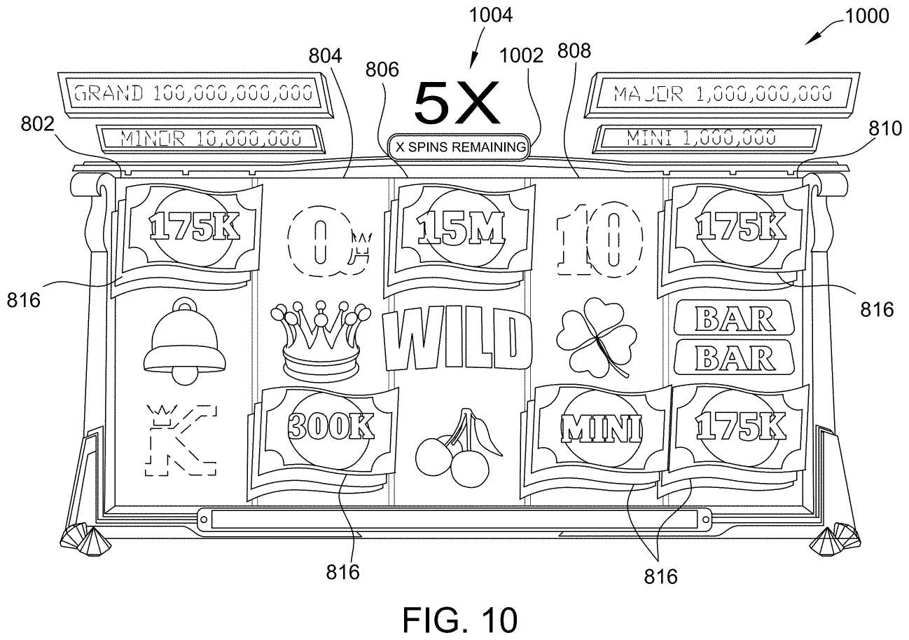

In the example shown in FIG. 8, display of six bonus symbols 816 triggers a bonus game (e.g., as shown in FIG. 10). As described below with respect to FIG. 10, secondary currency may be spent by a player to enhance different aspects of the base game (shown in FIG. 11) or the bonus game. In the example embodiment, during the bonus game, each position on reels 802-810 are converted to individual reels. Positions including display of bonus symbols 816 are not spun in the bonus game, while positions not including display of bonus symbols 816 are spun during each spin of the bonus game. After the last spin of the bonus game, the player is awarded at least the amounts displayed on each bonus symbol 816 (e.g., bonus symbols 816 are WYSIWYG symbols in the bonus game). In some embodiments, if a WYSIWYG symbol appears at each position of reels 802-810 at the end of the bonus game, an additional jackpot may be awarded to the player. In some embodiments, the maximum value that can appear on a WYSIWYG symbol may increase as a player wager increases. In some embodiments, jackpot labels may appear on WYSIWYG symbols (e.g., MINI, MAJOR, etc.) during play of the bonus game. In some embodiments, jackpot labels may also appear on WYSIWYG symbols during play of the base game.

Further, in the example shown in FIG. 8, an animation may be displayed to a player thereof indicating that the game being played in display area 800 is a game in which secondary currency may be earned. As an example, “Collect Diamonds to Buy Bonuses” is displayed in display area 800 to indicate to a player that secondary currency (in this example, diamonds) may be earned by playing the game played in display area 800. Thus, the ability to earn secondary currency is communicated to players such that players searching for an electronic game to play are more likely to select the game shown in display area 800. Accordingly, the ability to earn secondary currency, and communication thereof to player, can be a powerful tool in encouraging players to play different electronic games.

In some embodiments, as a player wager increases, different jackpots may become eligible to be awarded to the player. For example, a spin after a smaller wager is placed may only be eligible to result in a MINOR jackpot being awarded, while a spin after a larger wager is placed may be eligible to result in the MINOR, MINI, MAJOR, and GRAND jackpots being awarded. In some embodiments, portions of display area 800 displaying the different jackpots and their amounts may communicate which jackpots are eligible to be won by the player. For example, during a particular spin, if the MINOR and MINI jackpots are eligible to be won, the portions of display area 800 displaying the MINOR and MINI jackpots may light up (e.g., appear brighter than portions of display area 800 displaying the MAJOR and GRAND jackpots).

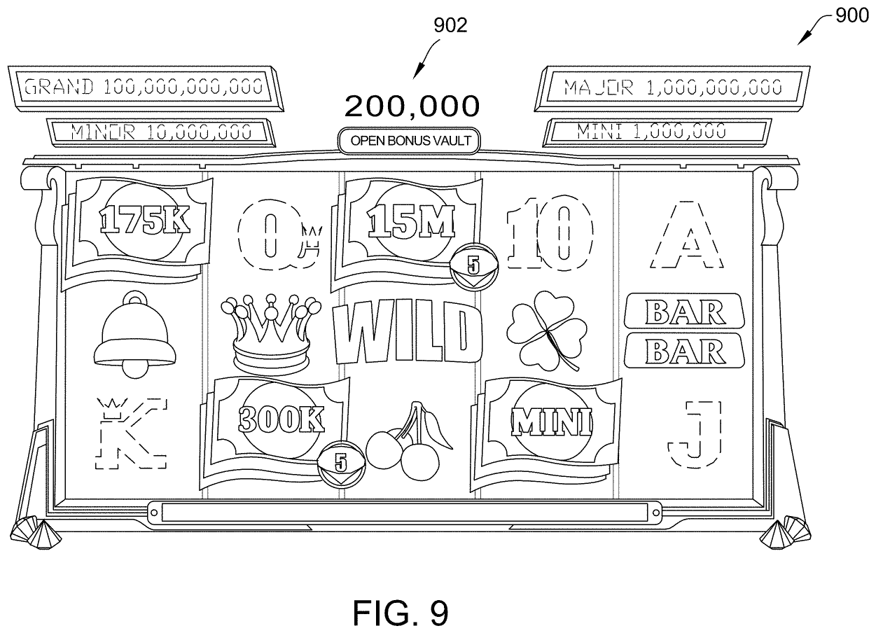

FIG. 9 is another example display area 900 displayed during a base game played on a display of a display device. The example in FIG. 9 demonstrates that a balance 902 of secondary currency may be displayed to a player during play of an electronic game as described herein. For example, as shown in FIG. 9, player balance 902 of secondary currency is currently 200,000 gems. In some embodiments, secondary currency balance 902 may be displayed in a variety of locations in display area 900. In some embodiments, balance 902 of secondary currency may be specific to a particular game (e.g., can only be earned and/or spent in one particular game). In some embodiments, balance 902 of secondary currency may represent a balance of secondary currency that can be earned and spent across a variety of games, in a variety of different manners (e.g., as a daily award), and or at a variety of locations (e.g., a land-based casino, a virtual game at an EUD, etc.) as described herein.

FIG. 10 is an example display area 1000 displayed during a bonus game played on a display of a display device as described above with respect to FIG. 8. As explained above, during play of the displayed example bonus game, each position of reels 802-810 is converted to an individual reel. A player is awarded a number of spins for play of the bonus game as displayed on spin meter 1002 (e.g., indicating the number of spins remaining). Further, a bonus may be applied to the bonus game by spending secondary currency. As shown in FIG. 10, bonus display area 1004 indicates a player has spent secondary currency to earn an award multiplier. Accordingly, the award presented to the player at the end of the bonus game will be multiplied by five, as currently indicated in bonus display area 1004. Different enhancements may be purchased with secondary currency for play of at least the base game and/or bonus game as described below with respect to FIG. 11.

As explained above, each individual reel already displaying a bonus symbol 816 is held (e.g., not spun) during each spin of the bonus game, while individual reels not displaying a bonus symbol 816 are spun. After no spins remain, the player is awarded at least the award values displayed on bonus symbols 816. However, as explained above, because the player has purchased a game enhancement with secondary currency in the example shown in FIG. 10, the award values displayed on bonus symbols 816 will be multiplied by five before being presented to a player. In some embodiments, a GRAND jackpot may be awarded to the player if each individual reel displays a bonus symbol 816 after a spin during the bonus game.

FIG. 11 is an example display area 1100 displayed during an electronic game played on a display of a display device when a player is browsing and/or selecting options for spending secondary currency. Display area 1100 includes a virtual catalog page 1102 including mystery bonuses 1104-1110 that may be purchased with secondary currency, and a user instruction display area 1112 that communicates information to a player regarding virtual catalog page 1102.

As shown on page 1102, each page 1102 may include a theme (e.g., New York, as shown in FIG. 11). In some embodiments, different animations displayed in an electronic game may correspond to a particular page theme. For example, if a player most recently viewed the New York page, when the player returns to game play an animation of different buildings in New York may appear in the background.

Page 1102 as shown includes three unlocked bonuses 1104-1108 and six locked bonuses 1110. In the example embodiment, bonuses 1104-1110 may be unlocked by spending secondary currency (e.g., 2,000 diamonds as shown on page 1102). In the example shown on page 1102, once a bonus is purchased, the bonus to be awarded to the player is randomly determined (e.g., by game controller 202 including RNG 212). In some embodiments, bonuses may be predetermined. In some embodiments, bonuses may be shown to a player before they are purchased (e.g., the bonuses are shown at locked symbols instead of reading “Mystery Bonus” as shown in FIG. 11). As examples, bonuses may include an amount of coins to be awarded to a player (e.g., primary currency, as shown at bonus 1104), a multiplier to be awarded to a player during play of an electronic game (e.g., as shown at bonus 1106), a number of gems to be awarded to a player (e.g., secondary currency, as shown at bonus 1108), and/or a number of free spins to be awarded to a player during of a bonus game (e.g., as shown in FIG. 10).

In some embodiments, upon unlocking a particular mystery bonus 1104-1110, the bonus 1104-1110 is immediately applied. As examples, when a player unlocked bonuses 1104-1108, those bonuses were applied to the player account (e.g., 3,750 coins as shown at bonus 1104 and 2,000 gems as shown at bonus 1108) or to an electronic game (e.g., 5× multiplier as shown at bonus 1106). In some embodiments, unlocked bonuses may be saved and applied later on. For example, a player may desire to use the 5× multiplier shown at bonus 1106 at a later time. In these examples, bonuses 1104-1110 are saved in a memory (e.g., memory 208) and associated with a player account of the player such that the player can activate a stored bonus at a later time.

User instruction display area 1112 may communicate information to a player regarding catalog page 1102 or any other aspect of an electronic game as described herein. For example, as shown in FIG. 11, display area 1112 communicates to a player that once all of mystery bonuses 1104-1110 have been purchased, a New York Mega Bonus Game will be initiated including the possibility of 5× award multipliers included therein.

In some embodiments, different catalog pages 1102 may be included in a catalog. In some embodiments, a player is required to unlock each bonus 1104-1110 before viewing the next page in the catalog. In other embodiments, a player may be able to view each page in the catalog before unlocking each bonus 1104-1110 on a page. In some embodiments, a player may have to earn tertiary currency (e.g., specialized gold diamonds) to unlock different pages in the catalog. In some embodiments, the amount of secondary currency required to unlock a bonus 1104-1110 may increase from page to page of the catalog (e.g., bonuses on a first page 1102 of the catalog cost the least amount of secondary currency while bonuses on a last page 1102 of the catalog cost the most amount of secondary currency). In some embodiments, the bonuses awarded may increase from page to page of the catalog (e.g., bonuses 1104-1110 on a first page 1102 of the catalog are of less value than bonuses 1104-1110 on a second page 1102 of the catalog, and so forth). In the example embodiment, different catalog pages 1102 are themed after different cities (e.g., New York City, Tokyo, London, etc.)

As explained above, various improvements including user interface improvements are provided by the EGM when the EGM executes the example game shown in FIGS. 8-11. As examples, the EGM may store and utilize multiple pay tables to determine primary currency and secondary currency payouts, improve data storage for storing and tracking primary currency and secondary currency, and enable players to use secondary currency in multiple electronic games. Further improvements include the EGM providing a secondary currency that may be spent and acquired at land-based casinos and in virtual environments, providing an improved user interface to communicate to players how to earn secondary currency in addition to primary currency; and providing an improved user interface to communicate to players a balance of primary currency and secondary currency.

While the invention has been described with respect to the figures, it will be appreciated that many modifications and changes may be made by those skilled in the art without departing from the spirit of the invention. Any variation and derivation from the above description and figures are included in the scope of the present invention as defined by the claims.

What is claimed is:

1. An electronic gaming system comprising:
at least one display device;
a player input interface;
a game controller; and
a tangible, non-transitory, computer-readable medium, storing instructions, which, when executed by the game controller, cause the game controller to at least:
receive a wager amount of a first currency at the player input interface;
cause a first electronic game to be displayed on the at least one display device;
determine, based on a first random number generator (RNG) call, an outcome of the first electronic game;
determine, based at least on the outcome of the first electronic game, the wager amount, and a first pay table, whether to display a primary award including the first currency;
determine, based on a second RNG call and a second pay table, that a secondary award is to be displayed on the at least one display device, the secondary award including a secondary currency different from the first currency; and
cause display of the secondary award on the at least one display device, the secondary award comprising the secondary currency.

2. The electronic gaming system of claim 1, wherein the instructions further cause the game controller to receive an input of secondary currency at the player input interface, wherein the input of secondary currency causes an additional feature to be activated for at least one future play of the first electronic game.

3. The electronic gaming system of claim 1, wherein the instructions further cause the game controller to receive an input of secondary currency at the player input interface, wherein the input of secondary currency causes an additional feature to be activated for at least one future play of a second electronic game, wherein the second electronic game is different from the first electronic game.

4. The electronic gaming system of claim 3, wherein the instructions further cause the game controller to execute the second electronic game at an electronic gaming machine (EGM).

5. The electronic gaming system of claim 1, wherein the instructions further cause the game controller to configure the secondary currency for use in virtual electronic gaming environments and land-based electronic gaming environments.

6. The electronic gaming system of claim 5, further comprising a player tracking system server, wherein the player tracking system server is configured to track an amount of secondary currency in a player account of a player and transmit an amount of secondary currency in the player account to at least one of an EGM and an end user device.

7. The electronic gaming system of claim 1, wherein the instructions further cause the game controller to receive an input of secondary currency at the player input interface, wherein the secondary currency is inputted as a wager amount for at least one future play of an electronic game different from the first electronic game.

8. The electronic gaming system of claim 1, wherein the instructions further cause the game controller to present secondary currency to a player on a periodic basis.

9. The electronic gaming system of claim 1, wherein the instructions further cause the game controller to present secondary currency to a player upon a predetermined number of plays of the first electronic game being played.

10. The electronic gaming system of claim 1, wherein the instructions further cause the game controller to present secondary currency to a player upon the player playing the first electronic game for a predetermined amount of time.

11. The electronic gaming system of claim 1, wherein the instructions further cause the game controller to present secondary currency to a player based on an outcome of a bonus game.

12. The electronic gaming system of claim 1, wherein the instructions further cause the game controller to determine an amount of secondary currency included in the secondary award, wherein the amount of secondary currency is determined based at least in part on a second wager amount of the secondary currency placed by a player.

13. The electronic gaming system of claim 1, wherein the instructions further cause the game controller to present a player with an amount of the secondary currency at a predetermined time interval.

14. The electronic gaming system of claim 1, wherein the instructions further cause the game controller to receive an input of secondary currency at the player input interface, wherein the input of secondary currency enables at least one additional spin during play of a bonus game.

15. The electronic gaming system of claim 1, wherein the instructions further cause the game controller to receive an input of secondary currency at the player input interface, wherein the input of secondary currency enables re-play of an entire bonus game.

16. The electronic gaming system of claim 1, wherein the instructions further cause the game controller to receive an input of secondary currency at the player input interface, wherein the input of secondary currency enables improved return to player (RTP) of the first electronic game.

17. The electronic gaming system of claim 1, wherein the instructions further cause the game controller to receive an input of secondary currency at the player input interface, wherein the input of secondary currency triggers initiation of a bonus game.

18. The electronic gaming system of claim 1, wherein the instructions further cause the game controller to analyze an amount of secondary currency accumulated by a player and present an additional award to the player upon determining that the player has accumulated a predetermined amount of secondary currency.

19. The electronic gaming system of claim 1, wherein the instructions further cause the game controller to determine to display the secondary award including the secondary currency, wherein the secondary currency is usable in at least one other electronic game.

20. The electronic gaming system of claim 1, wherein the instructions further cause the game controller to determine to display the secondary award based further on the outcome of the first electronic game.
